(19) United States
(12) Patent Application Publication
(10) Pub. No.: US 2011/0167986 A1
(43) Pub. Date: Jul. 14, 2011

(54) EQUIPMENT STAND

(76) Inventor: James R. Hennessey, West Hartford, CT (US)

(21) Appl. No.: 13/004,195

(22) Filed: Jan. 11, 2011

Related U.S. Application Data
(60) Provisional application No. 61/294,668, filed on Jan. 13, 2010.

(51) Int. Cl. G10G 5/00; F16M 11/02; F16M 11/22

(52) U.S. Cl. 84/453; 248/176.3; 248/440.1

(57) ABSTRACT

An equipment support stand comprises an upright member having an upper shaft, a lower shaft having an engaging structure located thereon, and an adjusting clutch connecting the upper shaft and the lower shaft. The stand also comprises means for locating equipment on an upper end of the upper shaft and a base assembly located on a lower end of the lower shaft. The base assembly comprises a support housing and receiving structure for cooperating with the engaging structure located on the lower shaft. The receiving structure is copperative with the engaging structure on the lower shaft to prevent the rotation of the lower shaft relative to the base assembly.

### CROSS REFERENCE TO RELATED APPLICATION

This application claims the benefit of U.S. provisional application No. 61/294,668, filed Jan. 13, 2010, the contents of which are incorporated herein by reference in their entirety.

### TECHNICAL FIELD

The present invention is directed in general to equipment stands and, more particularly, to a stand for microphones and/or musical equipment in which an upright member of the stand can be adjusted for height without undesired axial rotation of the upright member or members.

### BACKGROUND

A stand for supporting equipment such as microphones, lights, and musical equipment such as cymbals and sheet music holders generally has a lower member that extends vertically from a floor and an upper member that slides in and out of the lower member for height adjustment. The lower member is set on the floor and supported using a legged base, and the upper member can be fixed at any desired height to set the position of the supported equipment.

The upper and lower vertical members are usually loosened from or tightened to each other by a twisting or torsional motion of a clutch. Such twisting or torsional motion can result in the rotational movement of the upper vertical member. Microphones, lights, or musical equipment mounted to the upper vertical member also rotate accordingly. Particularly with regard to equipment that is mounted on a boom attached to the upper vertical member, such rotational motion often results in an undesirable movement of the equipment that causes a distraction to the user and/or detracts from a performance.

### SUMMARY

In one aspect, the present invention resides in an equipment support stand. Such a stand comprises an upright member having an upper shaft, a lower shaft having an engaging structure located thereon, and an adjusting clutch connecting the upper shaft and the lower shaft. The stand also comprises means for locating equipment on an upper end of the upper shaft and a base assembly located on a lower end of the lower shaft. The base assembly comprises a support housing and receiving structure for cooperating with the engaging structure located on the lower shaft. The receiving structure is cooperative with the engaging structure on the lower shaft to prevent the rotation of the lower shaft relative to the base assembly.

In another aspect, the present invention resides in a musical equipment support stand. Such a stand comprises an upper shaft having an attachment point located thereon for mounting musical equipment, a microphone, or a light, a lower shaft slidably attached to the upper shaft via an adjusting clutch, and a base assembly located on the lower shaft. A keyway is located in the base assembly. The lower shaft includes a tab located on a lower end thereof, the tab being engageable with the keyway in the base assembly to prevent the rotation of the lower shaft relative to the base assembly.

In another aspect, the present invention resides in a support stand for a microphone. Such a support stand comprises an upright member having an upper shaft adjustably connected to a lower shaft via an adjusting clutch, an attachment point located on an upper end of the upper shaft, a boom mounted on the attachment point, means for mounting a microphone on the boom, and a base assembly located on a lower end of the lower shaft. A tab is formed or otherwise located on the lower shaft and extends along a length thereof. The base assembly comprises a keyway formed therein and is configured to receive the tab such that engagement of the tab with the keyway prevents axial rotation of the upright member relative to the base assembly.

### BRIEF DESCRIPTION OF THE DRAWINGS

FIG. 1 is a perspective view of an equipment stand of the present invention.

FIG. 2 is a perspective view of a head on the equipment stand of FIG. 1 to which a boom portion is attached.

FIG. 3 is a perspective view of the boom of the equipment stand of FIG. 1.

FIG. 4A is a perspective view of a lower shaft of an upright member of the equipment stand of FIG. 1.

FIG. 4B is a perspective view of an alternate embodiment of a lower shaft of an upright member of the equipment stand of FIG. 1.

FIG. 5A is a top cross sectional view of a portion of a base assembly located on the lower shaft of FIG. 4A.

FIG. 5B is a top cross sectional view of a portion of a base assembly located on the lower shaft of FIG. 4B.

FIG. 6 is a side cross sectional view of the portion of the base assembly of FIG. 5A.

### DETAILED DESCRIPTION

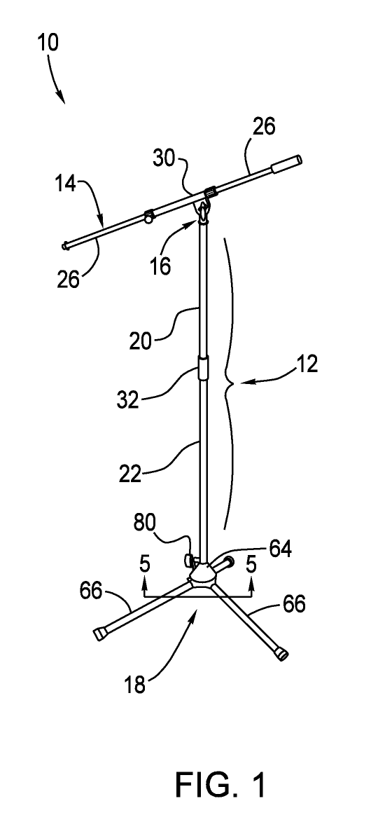

As shown in FIG. 1, an equipment stand for supporting a microphone is designated generally by the reference number 10 and is hereinafter referred to as “stand 10.” Although the stand 10 is described herein as accommodating a microphone, the present invention is not limited in this regard as lights, musical equipment, or other equipment may be used in conjunction with the stand. The stand 10 is defined by an upright member 12, a boom 14 attached thereto at a top attachment point 16, and a base assembly 18 located at a lower end of the upright member 12. The upright member 12 comprises an upper shaft 20 and a lower shaft 22, both shafts being tubular (e.g., cylindrical, angular, or the like) with the lower shaft having an inside diameter or size that is substantially equal to the outside diameter or corresponding size of the upper shaft so as to allow the upper shaft to slide in the lower shaft. The upright member 12 is not so limited, as the upper shaft 20 may slide over the lower shaft 22 of the upright member. The boom 14, which accommodates mounting of the microphone, lights, musical equipment, or other equipment, comprises a boom shaft 26 that is tubular and slidable in an attachment sleeve 30 mountable to the attachment point 16. The stand 10 is not limited to the inclusion of the boom 14 on which the equipment is mounted, as the microphone or other equipment may be mounted on the top attachment point 16.

With regard to the upright member 12, the upper shaft 20 is slidable in and fixable to the lower shaft 22 via a mid-point clutch 32 located on the lower shaft. The mid-point clutch 32 allows the upper shaft 20 to be locked to the lower shaft 22 to prevent movement of the upper shaft relative to the lower shaft.

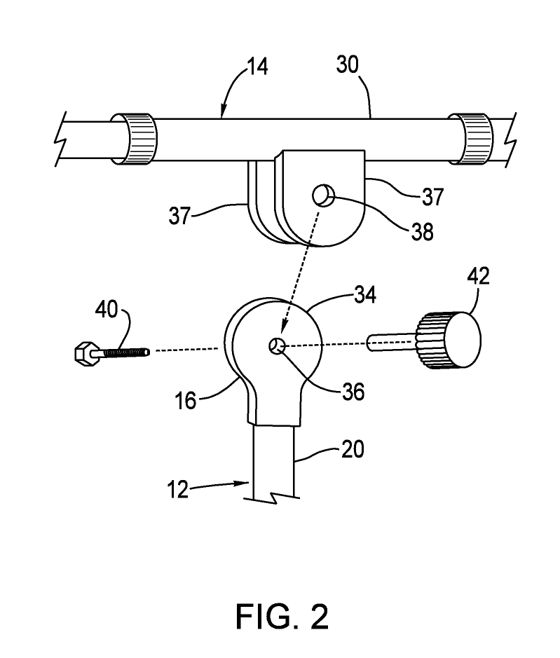

As shown in FIG. 2, the top attachment point 16 is located at an upper end of the upper shaft 20 of the upright member 12 and comprises suitable structure that allows for the connection of the boom 14. Suitable structure of the top attachment point 16 may be defined by a head 34 having a hole 36 extending therethrough. The head 34 may be rotatable on the upper end of the upper shaft 20 to allow the boom to be rotated 360 degrees around the attachment point 16. Two ears 37 depend from the attachment sleeve 30, each ear 37 having a hole 38. Each ear 37 is received on opposing sides of the head 34 such that the hole 36 registers with the holes 38 on each ear 37. A bolt 40 is inserted through the hole 36 and the holes 38 and is threadedly secured using a knob 42. The bolt 40 may be a carriage bolt having a shaped surface below the head thereof, the shaped surface being configured to correspond to a shape that defines at least a portion of the hole 38, thereby allowing the bolt to be received in the hole 38 without turning when the knob 42 is tightened. The threaded engagement of the knob 42 on the bolt 40 provides a tightening mechanism that enables the boom 14 to be set at any desired angle. Upon loosening the knob 42, the boom 14 can be adjusted to any angle. The attachment point 16 is not limited as described above, however, as any suitable pivotal and/or rotational attachment configuration may be employed. The present invention is also not limited to the attachment of a boom 14 on the upright member 12, as any other device (for example, a sheet music stand, instrument stand, other extension member, or the like) may be attached.

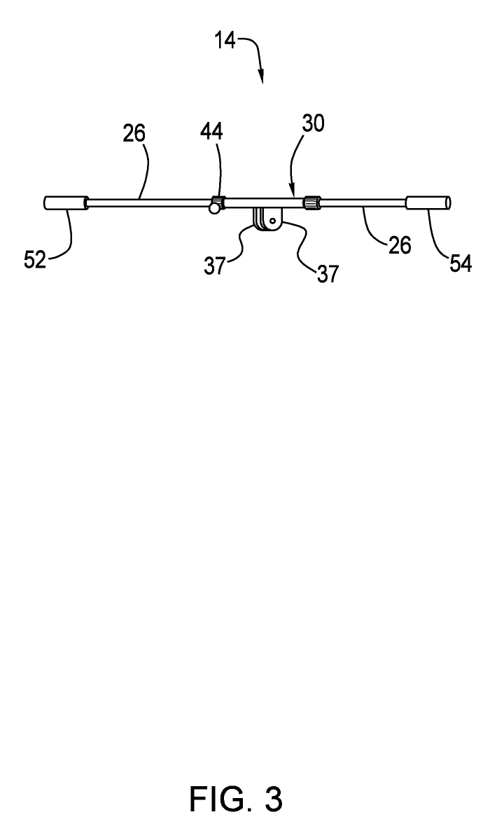

As shown in FIG. 3, the boom shaft 26 is slidably mounted in the attachment sleeve 30. A clutch or a threaded screw with a knob 44 is used to set the position of the boom shaft 26 within the attachment sleeve 30. One end of the boom shaft 26 includes a weight 52 or at least a stop flange to prevent sliding of the boom shaft completely through the attachment sleeve.

The end of the boom shaft 26 opposite the weight 52 includes a microphone sleeve 54 in which a microphone may be mounted. As stated above, the present invention is not limited to the use of a microphone mounted in a microphone sleeve on the boom, however, as other equipment such as a light or musical equipment such as a cymbal or a sheet music holder may be mounted on the boom 14.

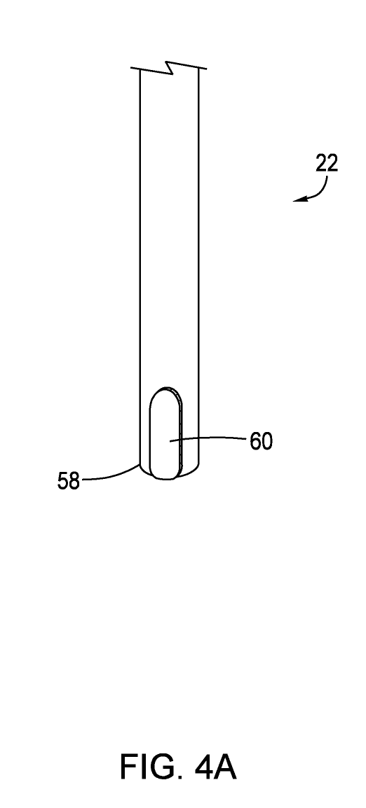

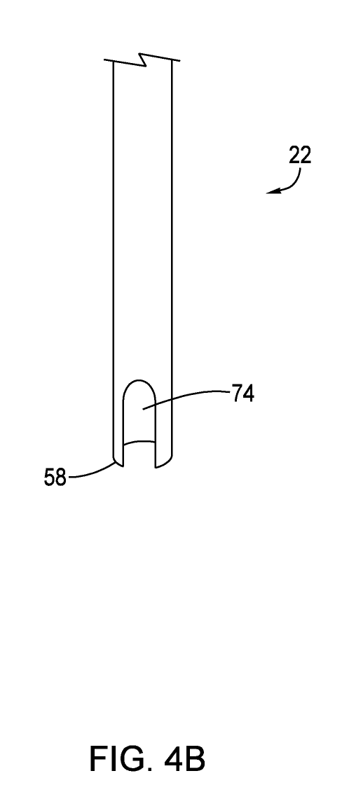

Referring back to FIG. 1 and as further shown in FIG. 4A, a lower end 58 of the lower shaft 22 includes an engaging structure such as a tab 60 welded onto or otherwise disposed on an outer surface thereof to define a raised area that extends along a portion of the lower shaft. The present invention is not limited to the tab 60 being welded or otherwise disposed onto the outer surface of the lower shaft 22, however, as the inner surface of the lower shaft may be stamped to produce a raised area on the outer surface. Moreover, as further shown in FIG. 4B, the lower end 58 of the lower shaft 22 may include engaging structure in the form of a slot 74 or similar structure that defines a recessed area.

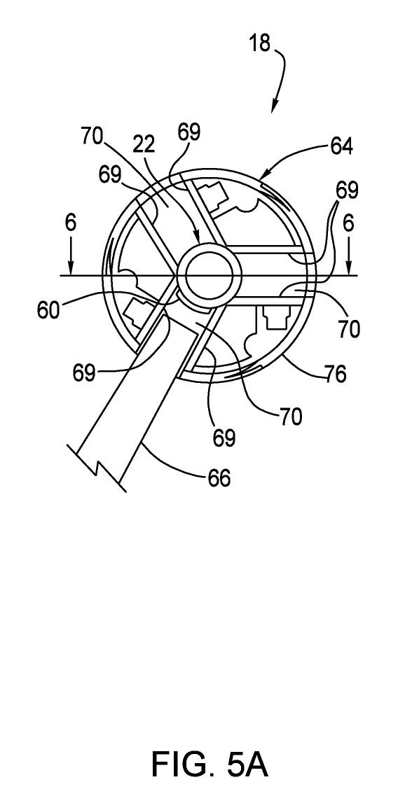

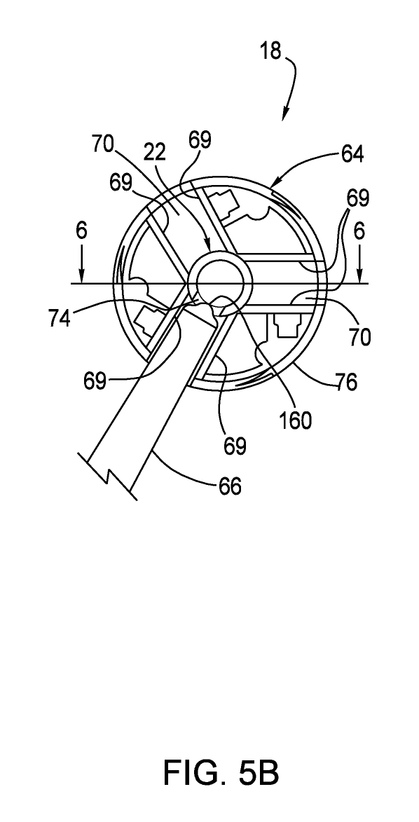

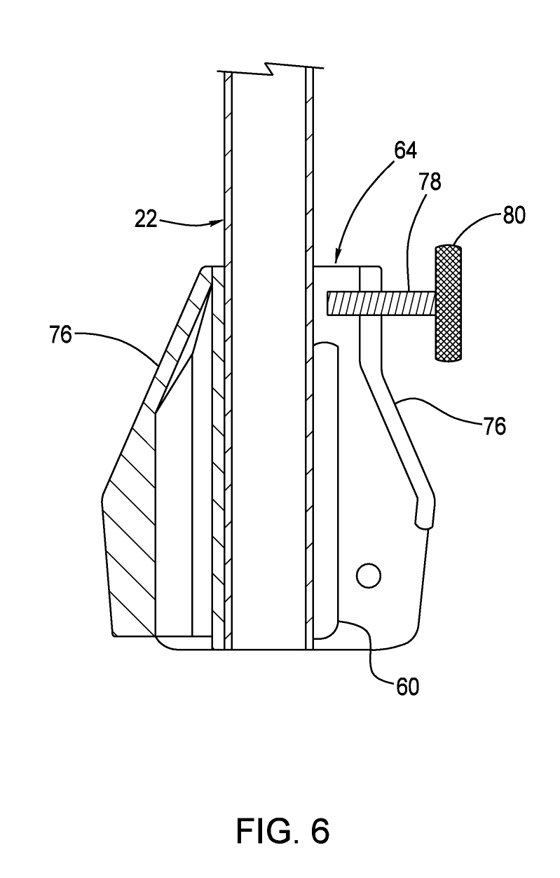

Referring back to FIG. 1 and as further shown in FIGS. 5A and 6, the base assembly 18 is defined by a support housing 64 comprising suitable elements such as legs 66 (only one shown in FIG. 5A) attached thereto, the support housing having receiving structure configured to cooperate with the lower shaft 22 to support the stand 10 in an upright position. The legs 66 are hingedly arranged on the support housing 64. When the legs 66 are folded out, they form a tripod. The present invention is not limited to the legs 66 forming a tripod, however, as more than three legs 66 may be employed.

The support housing 64 includes receiving structure such as walls 69 that define keyways 70 in which the legs 66 are hingedly connected. Upon receiving the lower end of the lower shaft 22 into the support housing 64, the tab 60 is received in one of the keyways 70. Upon adjustment of the mid-point clutch 32, axial rotation of the lower shaft 22 relative to the support housing 64 is prevented because the tab 60 is captured between the walls 69 defining the keyway 70. The present invention is not limited to the receiving of the tab 60 in the keyway 70 to prevent rotation of the lower shaft 22, however, as one or more of the legs 66 may include a protrusion 160 (FIG. 5B) that is received in a lower shaft 22 having the slot 74. In such a configuration, opening the legs 66 causes the protrusion 160 to engage the slot 74, thereby preventing axial rotation of the lower shaft 22 relative to the support housing 64.

As is shown in FIGS. 1 and 6, the support housing 64 includes a cover 76 located over the support housing. A screw 78 extends through the cover 76 to engage the lower shaft 22. A knob 80, lever, or other device is located on one end of the screw 78 to allow the screw to be tightened and loosened, thereby securing the lower shaft to the support housing (or releasing the lower shaft from the support housing).

To operate the stand 10, the support housing 64 is moved to the lower end of the lower shaft 22 and secured in place by tightening the screw 78. In doing so, either the tab 60 is received between the walls 69 of one of the keyways 70, or the protrusion 160 is received in the slot 74 when the legs 66 are folded out. In either case, the lower shaft 22 (and thereby the upright member 12 and the boom 14) is prevented from rotation while the mid-point clutch 32 is manipulated to adjust the overall height of the stand 10. The lower shaft 22 cannot rotate irrespective of the amount of torsional stress exerted on the lower shaft when the mid-point clutch 32 is adjusted to lock or unlock the upper shaft 20 relative to the lower shaft. Upon loosening the screw 78, the support housing 64 can be slid along the lower shaft 22 to disengage the tab 60 from the keyway 70. In embodiments in which the protrusion 160 is received in the slot 74, the protrusion is disengaged from the slot 74 when the legs are folded in.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the foregoing description.

What is claimed is:

1. An equipment support stand, comprising:
an upright member comprising,
an upper shaft,
a lower shaft having an engaging structure located thereon, and
an adjusting clutch connecting the upper shaft and the lower shaft;
means for locating equipment on an upper end of the upper shaft; and
a base assembly located on a lower end of the lower shaft, the base assembly comprising,
a support housing, and
receiving structure for engaging the engaging structure located on the lower shaft, the receiving structure being selectively engageable with the engaging structure on the lower shaft to prevent the rotation of the lower shaft relative to the base assembly.

2. The equipment stand of claim 1, wherein the engaging structure comprises a tab projecting from a surface of the lower shaft.

3. The equipment stand of claim 2, wherein the receiving structure comprises a keyway defined by two opposing walls located in the support housing.

4. The equipment stand of claim 1, wherein the engaging structure comprises a slot formed in a surface of the lower shaft.

5. The equipment stand of claim 4, wherein the receiving structure comprises a protrusion on the base assembly over which the slot formed in the lower shaft is received.

6. The equipment stand of claim 1, wherein the base assembly includes a plurality of legs.

7. The equipment stand of claim 6, wherein the plurality of legs is arrangable in the form of a tripod.

8. The equipment stand of claim 1, wherein the means for locating equipment on the upper end of the upper shaft comprises a boom.

9. A musical equipment support stand, comprising:
an upper shaft;
an attachment point located on the upper shaft for the mounting of musical equipment;
a lower shaft slidably attached to the upper shaft via an adjusting clutch;
a base assembly located on the lower shaft, the base assembly including a keyway formed therein; and
a tab located on the lower shaft, the tab being engageable with the keyway in the base assembly to prevent the rotation of the lower shaft relative to the base assembly.

10. The musical equipment support stand of claim 9, wherein the keyway is defined by two substantially vertically oriented walls in the base assembly.

11. The musical equipment support stand of claim 9, further comprising a boom located on the attachment point to which the musical equipment can be mounted.

12. The musical equipment support stand of claim 11, wherein the boom is adjustable in length.

13. The musical equipment support stand of claim 9, further comprising a screw located in the base assembly, the screw being engageable with the lower shaft to secure the lower shaft to the base assembly.

14. A support stand for a microphone, the support stand comprising:
an upright member comprising an upper shaft adjustably connected to a lower shaft via an adjusting clutch, the lower shaft including a tab thereon;
an attachment point located on an upper end of the upper shaft;
a boom mounted on the attachment point;
means for mounting a microphone on the boom; and
a base assembly located on a lower end of the lower shaft, the base assembly comprising a keyway formed therein and configured to receive the tab such that engagement of the tab with the keyway prevents axial rotation of the upright member relative to the base assembly.

15. The support stand of claim 14, wherein the keyway is defined by two substantially vertically oriented walls in the base assembly.

16. The support stand of claim 14, wherein the base assembly further comprises a screw engageable with the lower shaft, the screw being configured to be adjusted to secure the lower shaft in the base assembly and to release the lower shaft from the base assembly.

17. The support stand of claim 14, wherein the base assembly further comprises a plurality of legs to support the upright member in a vertical orientation.

18. The support stand of claim 14, wherein the means for mounting the microphone on the boom comprises a sleeve.
